(19) United States
(12) Patent Application Publication
(10) Pub. No.: US 2013/0101961 A1
(43) Pub. Date: Apr. 25, 2013

(54) DENTAL IMPLANT WITH ANTIROTATIONAL COG

(71) Applicant: Ronald A. Bulard, Ardmore, OK (US)

(72) Inventor: Ronald A. Bulard, Ardmore, OK (US)

(21) Appl. No.: 13/701,645

(22) PCT Filed: Jun. 8, 2011
(86) PCT No.: PCT/US11/39602

§ 371 Date: Jan. 11, 2013

Related U.S. Application Data
(60) Provisional application No. 61/352,562, filed on Jun. 8, 2010.

(51) Int. Cl. A61C 8/00

(52) U.S. Cl. CPC A61C 8/0025
USPC 433/174

(57) ABSTRACT

A one-piece dental implant for placement into bone, the one-piece dental implant extending between a coronal end and an apical end, and the one-piece dental implant having a threaded shaft tapering to a point at the apical end, wherein the threaded shaft has a series of self-tapping cutting threads, a collar having at least one ring with a path that includes a diversion, and an anti-rotational cog traversing a plurality of said the threads. Also, disclosed is a non-surgical method of placing a dental implant by providing the dental implant, providing a starting bore through a patient's gum into said patient's jaw bone, and threading the dental implant through the starting bore into the patient's jaw bone.

### BACKGROUND OF THE INVENTION

1. Field of the Invention

The present invention relates to dental implants, orthodontic anchor screws, orthopedic screws, and any other screw or rod placed into bone.

2. Description of Related Art

U.S. Pat. No. 7,597,557 describes a dental implant fitted with a straight, spiral or oblique tap toward the apical end thereof. The tap is long and, in a preferred embodiment, goes through more than a third of the implant crossing several threads. This design of the tap is alleged to facilitate insertion of the implant into bone, the theory being that because only part of one thread is cutting the bone the resistance for insertion is lower. The implant can be fitted with more than one tap, preferably two.

This implant still suffers the possibility that after it is inserted into bone, it may work itself loose. Consequently, there remains a need in the art for dental implants having a reduced tendency to unseat themselves.

Cell migration that initiates from the gingival tissue can travel in an apical direction towards and into the outer threaded section of an implant. Such cell migration into the threaded section can slow and even prevent full osseointegration of the threaded section of the implant into bone, which is a primary objective of implant placement.

### SUMMARY OF THE INVENTION

These and other objects were met with the present invention, which relates in a first embodiment to a one-piece dental implant for placement into bone, said one-piece dental implant extending between a coronal end and an apical end, and said one-piece dental implant comprising a threaded shaft tapering to a point at said apical end, wherein the threaded shaft comprises a series of self-tapping cutting threads, and an anti-rotational cog traversing a plurality of said cutting threads.

The present invention relates in a second embodiment to a non-surgical method of placing a dental implant, said method comprising:
(a) providing the dental implant as described herein;
(b) providing a starting bore through a patient's gum into said patient's jaw bone; and
(c) threading said dental implant through said starting bore into said patient's jaw bone.

The present invention relates in a third embodiment of the present invention, which relates to a dental implant, wherein the implant has a tapered collar with a ring, the ring having a path following along a base; wherein the ring comprises a diversion, whereby the diversion inhibits cellular migration along the path of the ring.

### BRIEF DESCRIPTION OF THE DRAWINGS

The invention will now be described in greater detail with reference to the drawings, wherein:

FIG. 1 is a series of schematics of a first embodiment of an implant according to the present invention;

FIG. 2 is a cross-section and a perspective of the implant of FIG. 1;

FIG. 3 is a series of schematics of a second embodiment of an implant according to the present invention;

FIG. 4 is a series of cross-sections of the implant of FIG. 3;

FIG. 5 is a perspective of the implant of FIG. 3;

FIG. 6 is a series of schematics of a third embodiment of an implant according to the present invention;

FIG. 7 is a series of schematics of a fourth embodiment of an implant according to the present invention;

FIG. 8 is a series of schematics of a fifth embodiment of an implant according to the present invention; and

FIG. 9 is a series of schematics of a sixth embodiment of an implant according to the present invention.

FIG. 10 is a series of schematics of a seventh embodiment of an implant according to the present invention.

### DETAILED DESCRIPTION OF THE INVENTION

The term “dental implant” is used throughout the application to describe one embodiment of the present invention. However, it should be understood that the invention also pertains, as indicated above, to orthodontic anchor screws, orthopedic screws, and any other screw or rod placed into bone.

The normal tendency of a seated implant is to turn out and loosen. This is true even of the implant of U.S. Pat. No. 7,597,557, wherein the thread projections, produced as a result of cutting the tap into the threaded shaft, are situated on the right-hand side of the clockwise turning implant so that they encounter and cut bone upon implant insertion. The antirotational cog of the present invention may superficially have a similar structure to the tap of U.S. Pat. No. 7,597,557, except that for the clockwise turning implant, the thread projections are situated on the left-hand side of the clockwise turning implant (or the right-hand side of a counter-clockwise turning implant) so that when the implant is inserted, these thread projections do not encounter the bone as a leading edge and, therefore, do not cut the bone. However, once the implant is seated, new bone or bone expanded after compression of the bone during auto-advancing will fill the interstices of the antirotational cog, and these thread projections will then rest against the new or expanded bone and be prohibited by the new or expanded bone from turning, thereby preventing or at least significantly reducing the tendency that the implant can turn sufficiently to unseat itself. With embodiments disclosed herein, the anti-rotational cog of the present invention may be absent from coronal and apical ends, or those having without cogs, of the implant threads. The resulting thread profile enables a dental professional placing the implant to align said ends of the implant threads against and into dense bone that occurs naturally in the jawbone.

Another cause of implants loosening derives from interactions taking place between a dental implant and the gingival tissue of a patient who has recently received a dental implant in jawbone. Gingival tissue may contain bacteria that, during and post implant surgery, can travel from the coronal end of an implant down the threaded section in an apical direction. Such bacteria slows osseointegration of the implant threads into surrounding jawbone, and in severe cases can cause infection of the jawbone that results in loosening and failure of the implant.

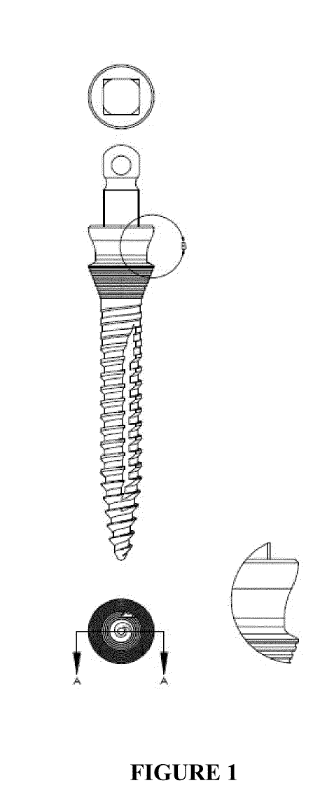

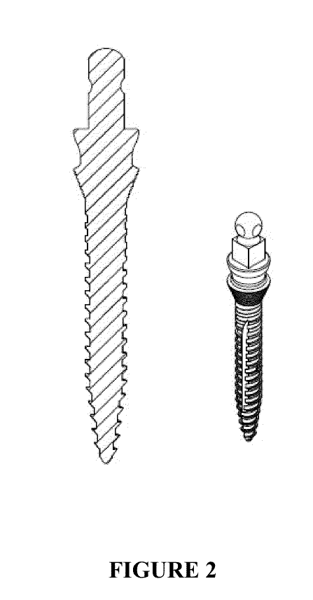

Referring to the drawings, a first embodiment of the dental implant according to the present invention is depicted in FIGS. 1 and 2. The dental implant of this first embodiment has a threaded shaft at the apical end, and a ball-shaped head at the coronal end. Between the threaded shaft and the ball-shaped head is a non-circular abutment, which can be seen from the overhead view at the very top of FIG. 1 is squared. Below the non-circular abutment is a tapered collar, the area encircled by B being enlarged in the depiction in the lower right-hand corner of FIG. 1. Traversing the threaded shaft, beginning at the third thread turn from the top and continuing down to the third thread turn from the bottom is a single antirotational cog. The depiction at the bottom left of FIG. 1 shows a view of the implant from the bottom, the single antirotational cog being clearly visible in the upper right-hand quadrant.

It is seen from the drawing in the lower left-hand corner of FIG. 1 that the antirotational cog in this embodiment is essentially a two-sided groove cut through the threads into the shaft beneath. The two-sides in this embodiment are at an angle approximating 60°, but this angle can be varied as desired from 15-90°, and preferably ranges anywhere from 45-75°. The groove cut depicted is more or less a straight-cut on both sides, i.e., a pie-cut, but this is not necessary, and the groove could be rounded at the vertex, or anywhere along either side of the groove.

The left-hand drawing of FIG. 2 shows the implant of FIG. 1 in cross-section. It is clearly seen that the cutting threads have a variable profile both in terms of the thickness of the cutting edge of each thread, and of the taper from the bottom-most point of the cutting edge to the threaded shaft. In this embodiment, the thickness of the cutting edge of each thread gradually decreases going from the coronal end to the apical end. At the same time, the taper from the bottom-most point of each cutting edge to the threaded shaft gradually increases going from the coronal end to the apical end. This shape of the cutting threads has the advantage that as the implant is inserted, bone is compressed both outward and between the threads, making for a more secure seating of the implant into bone. The presence of the antirotational cog serves to make sure that the secure seating is retained throughout the implant life for, as noted previously, after the interstices in the antirotational cog have been filled by new bone or by bone expanded from the compression of bone from auto-advancing the implant into the bone, the thread projections thereof prevent or reduce the ability of the implant to turn out and loosen.

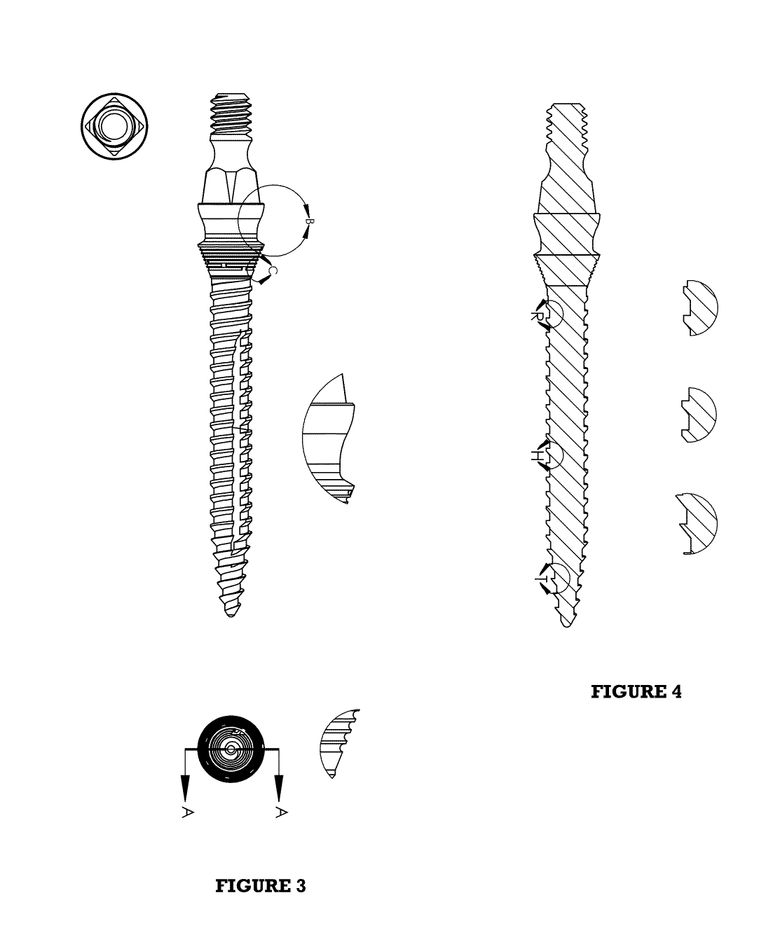

Referring to FIG. 3, shown is a dental implant having some of the same features of the dental implant of FIGS. 1 and 2, a main difference being that the dental implant of FIG. 3 has a screw head at the coronal end. This figure, thus, serves to illustrate what is an important aspect of the present invention, namely that the head at the coronal end can have any desired shape, for example, in addition to ball-shaped, or screw-shaped, also square, oval, triangular, mushroom, or any of the other head shapes depicted in U.S. Pat. No. 7,597,557, the entire contents of which are hereby incorporated by reference. Alternatively or in addition to, the head may be fitted with an i-hook, a square hole, a round hole, or a groove, or any other suitable combination of convex and concave surfaces optionally having flat portions as desired. The head shape can be irregular, if desired, but may also be regular. The shape of the head really is a matter of design choice, well within the skill of the ordinary practitioners in this art. Alternatively, the head can have a shape that is capable of accepting and removably retaining an O-ball, for example, an O-ball descending from the prosthesis itself. For example, the head of the inventive dental implant may be latched or slotted, allowing the head to latch and grip an O-ball. In the case of an oval-shaped head, a triangle-shaped head or a mushroom-shaped head, the head can retain a conventional O-ring, but use can also be made of a keeper cap adapted to be secured to the dental implant via the O-ring or a plastic insert specifically designed to accept and releasably grip the head.

In FIG. 3, once again, the portion of the tapered collar encircled by B is depicted to the upper right-hand side of the implant. A portion below the tapered collar is a restricted area simulating a platform switch that may be seen in conventional two piece implants, and a portion of that restricted area is encircled by C, and depicted to the lower right-hand side of the implant.

FIG. 3 highlights an additional embodiment of the invention. The tapered collar may be provided with a topography that includes one or more rings about the collar. The rings may be substantially parallel to one another. As further depicted in the restricted area encircled by C, an individual ring may comprise sides and a base, of which comprise the surface of the ring. Conceptually, a path exists along the surface of the ring that circumnavigates the distance around the collar of the implant. FIG. 3 shows the rings as having an arcuate base profile, though other ring surface profiles may be within the scope of the invention such as a squared or v-shaped base profile. Similarly, though the ring is generally depicted as a depression in the drawings, it is within the scope of this invention that the ring may be raised over the collar diameter rather than grooved into and within the collar's diameter.

According to a preferred embodiment, the ring may be provided with one or more junctions. The junction may represent a contact inhibitor in the ring that acts to slow or halt cellular migration by changing the course of the path from the base of the ring into a diversion. The term “diversion” as used herein means an instance of diverting or deviating from a course. As embodied in FIG. 3, the diversion may be understood as representing the entire deviation from the base of the ring, beginning with the junction. Looking again to FIG. 3, at a first junction the diversion projects upwards at approximately 90 degrees or generally perpendicular to the base of the ring. As shown, diversion includes a plateau that extends at an altitude from base of the ring, the diversion further comprising a second, third and fourth junctions where the path of the ring may change course along the diversion and ends at the fourth junction at the base of the same ring. According to a preferred embodiment, the plateau extends in a range of 0.2 mm to 0.3 mm, though the scope of the invention extends to a range of 0.05 mm to 3 mm. Plateau may have an elevation substantially equal to a height of the sides of the ring, according to a preferred embodiment of the invention. Other embodiments not shown contemplate an elevation of the plateau that is not equal to the height of the sides of the ring.

Other junctions not shown but within the scope of this invention may have diversions that project downward or at other angles in a range of 10 degrees to 120 degrees to the base of the ring, said other junctions also capable of disrupting cellular migration along the path of the ring.

According to another embodiment of the invention, the ring may comprise more than one diversion, creating multiple regions of contact inhibitors per ring. In yet another embodiment, a collar of the implant as otherwise disclosed herein is not tapered.

The dental implant of FIG. 3 is shown in cross-section in FIG. 4, the variable thread profile at different portions shown on the right-hand side of the drawing, the upper, middle and lower drawings corresponding to the portions encircled by R, H and T, respectively. Again, it is seen that the cutting threads have a variable profile both in terms of the thickness of the cutting edge of each thread, and of the taper from the bottom-most point of the cutting edge to the threaded shaft. The thickness of the cutting edge of each thread gradually decreases going from the coronal end to the apical end. At the same time, the taper from the bottom-most point of each cutting edge to the threaded shaft gradually increases going from the coronal end to the apical end.

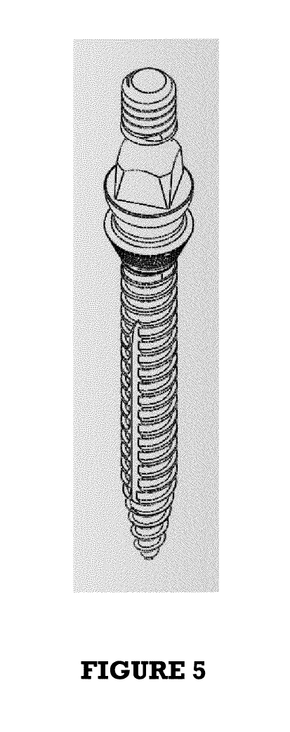

FIG. 5 shows the dental implant of FIG. 4 in perspective.

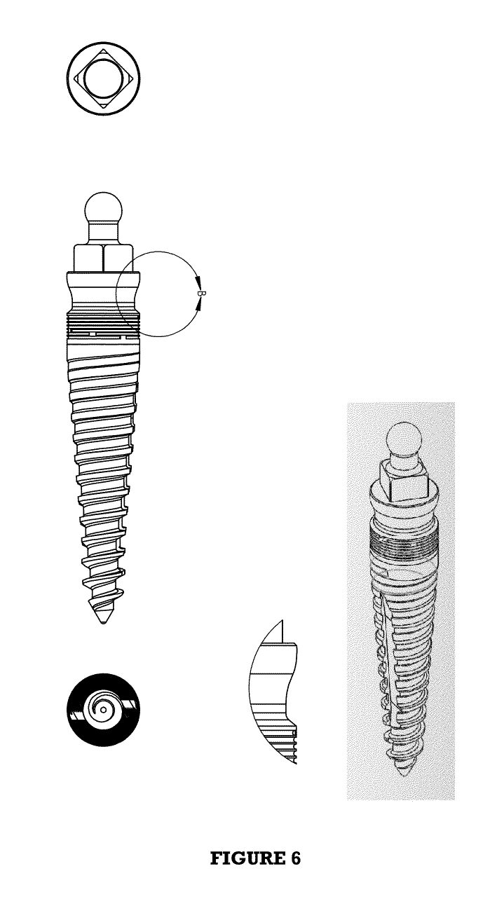

FIG. 6 relates to another embodiment of the present invention, which, like the implant shown in FIG. 1 has a ball-shaped head, the main difference being that the dental implant of FIG. 6 has three antirotational cogs, as clearly seen in the view from the bottom of the dental implant depicted at the lower left-hand corner of the drawing. Besides one or three antirotational cogs, other numbers of antirotational cogs, for example, two, four or five or more are possible. In the embodiment shown in FIG. 6, the three antirotational cogs are spaced equidistant around the circumference of the dental implant. Each antirotational cog has the same features as the antirotational cog of FIG. 1, but it is possible to design each antirotational cog independently to impart different holding properties to the resulting dental implant, and, also, to position the antirotational cogs other than equidistant from each other.

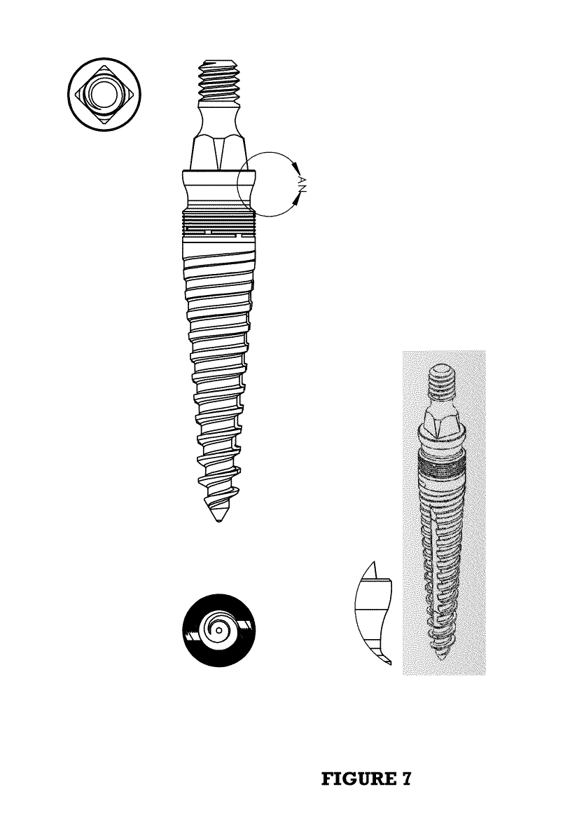

FIG. 7 depicts a three-anti-rotational cog implant like that of FIG. 6, but having a screw-shaped head.

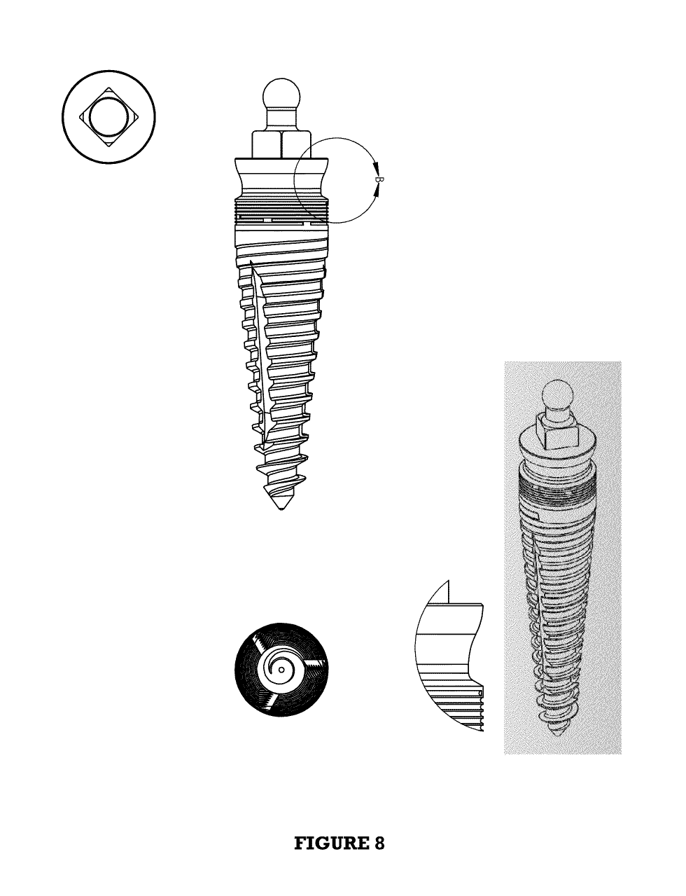

FIG. 8 depicts a dental implant having the features of the implant of FIG. 6, but being larger in width.

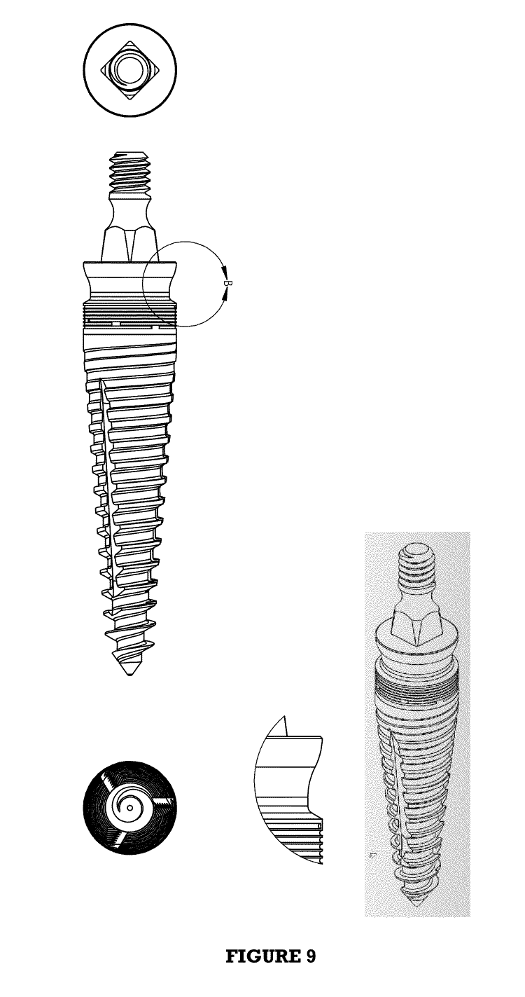

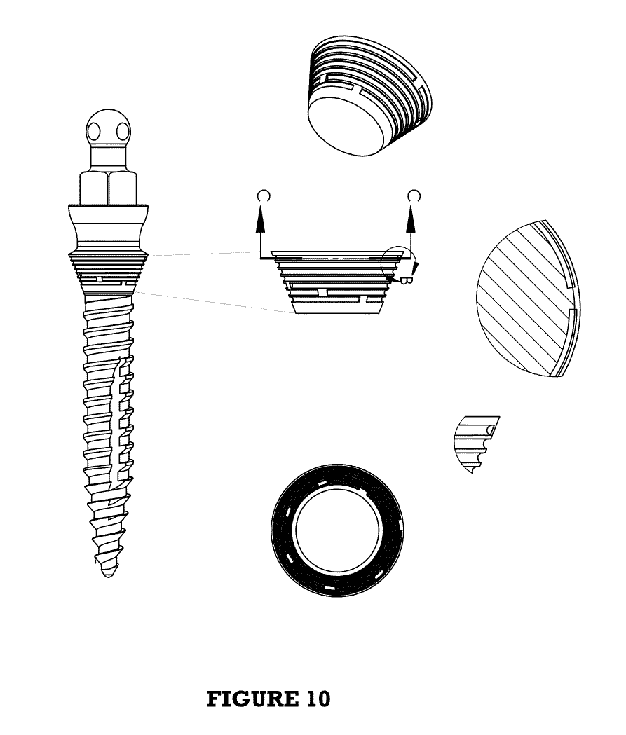

FIG. 9 depicts a dental implant having the features of the implant of FIG. 7, but being larger in width.

FIG. 10 depicts a side view of dental implant collar having topographies as previously discussed, including rings with junctions and diversions.

The dental implant dimensions are not critical, but preference is given to dimensions that qualify the dental implant as being a “mini-implant.” Most preferably, the inventive dental implant ranges in overall length from about 15 to about 25 mm, preferably from about 17 to about 22 mm. The threaded shaft comprises a tapered end, and ranges in diameter from about 1 to about 2 mm, and preferably about 1.8 mm. The length of the threaded shaft likewise ranges from about 10 to about 19 mm, and preferably from about 12 to about 17 mm. The thread design and positioning on the threaded shaft can be varied over a wide range. As shown, for example, in the figures, the helix of self-tapping cutting threads promotes progressive draw of the inventive dental implant into dense bone. A narrow apex of crest of thread form minimizes stress from rotational forces in penetrating dense materials, and also results in minimal torque being required to advance the inventive dental implant each revolution. Moreover, a fishbone-like shape reduces the likelihood of the inventive dental implant pulling out of bone. Where present, the non-circular abutment ranges in length from about 1.5 to about 4 mm, and is preferably about 2.5 mm in length. The non-circular abutment is preferably of square, triangular, hexagonal or any other shape that permits threaded advance of the threaded shaft by fingers or tools. As depicted, in a preferred embodiment, the ball-shaped head is attached to the non-circular abutment via a circular neck, which ranges in length from about 0.5 to about 1.5 mm, and is most preferably about 0.8 mm. The diameter of the circular neck, in turn, ranges from about 0.5 to about 1.8 mm, and is preferably about 1.4 mm. Finally, the ball-shaped head ranges in diameter from about 1 to about 2 mm, and is preferably about 1.7 mm.

The dental implant is formed of any strong metal or alloy thereof, and especially from titanium or an alloy thereof with another metal, for example, aluminum and/or vanadium. The best mode is to use a titanium alloy rod having the formula Ti₆Al₄V, which satisfies the American Society for Testing Materials F-136 (ASTM F-136).

Because of their small diameter compared with conventional implants, the inventive mini-implants can be placed without gum surgery. A small diameter drill is used to prepare a short cylindrical starting bore going right through the gum into the jaw bone. Because of its minute diameter there is almost no gum bleeding. As a matter of fact, the minute blood droplet on the gum serves as a marker to assist the dentist in the next step of placing the dental implant through the gum hole into the hidden-from-view jaw bone.

If desired, several drills of successively increasing diameters, but all still smaller than the dental implant diameter may be used. Other tools can be used to thread the dental implant into the jaw bone.

The implants are advantageously positioned along the apex-line for the jaw bone. While desirably parallel they might not be absolutely so but this does not pose a problem in the multiple placements and removals of the denture during fitting. Boring out the anchor holes in the denture bottom accommodates each fitting the final hardening locking the abutment heads in place.

If desired the dentist can even shape the placed abutment heads if he/she deems it advisable for parallelism.

The ultra-small width makes it uniquely possible for the inventive mini-implants to be inserted directly through the soft tissue into the underlying bone without any flap surgery incisions or sutures making for a much more patient-friendly procedure than is typical of conventional implant systems.

Further the ultra-slim width of the inventive mini-implants permits a minimal encroachment on usually sparse amounts of good quality tough epithelialized gum tissue making it all the more likely that the dental implant will be more comfortable not only at time of placement but during the aftercare period and beyond. O-ring inserts such as those of an elastomeric nature may be deployed about the head of the implant to absorb and minimize shock from occlusal forces and other trauma that may be detrimental to the success of an implant case.

Thus, the inventive mini-implants can be placed using the same nonsurgical method as described in my prior patent, U.S. Pat. No. 6,716,030, and all pertinent details are fully incorporated herein by reference.

Because the inventive dental implants have a one-piece design, they are not susceptible to the microleakage problems on the bacteria and ionic levels, which were characteristic of the prior art multiple-piece designs. Accordingly, the inventive dental implants are less likely to be rejected by the patient, less likely to lead to infection, and less likely to corrode.

Once the inventive dental implants have been positioned, they can be used for both fixed and removable prosthetic applications. The details of these procedures are well known to persons having ordinary skill in the art, and, therefore, these well known details are not repeated here. See, for example, Michael S. Block et al., Implants in Dentistry, W. B. Saunders Company, Philadelphia, Pa., 1997, the entire contents of which are incorporated herein by reference.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

1. A one-piece dental implant for placement into bone, said one-piece dental implant extending between a coronal end and an apical end, and said one-piece dental implant comprising a threaded shaft tapering to a point at said apical end, wherein the threaded shaft comprises a series of self-tapping cutting threads, and an anti-rotational cog traversing a plurality of said cutting threads.

2. The dental implant according to claim 1, which comprises a head at said coronal end.

3. The dental implant according to claim 1, wherein the head is a ball-shaped head.

4. The dental implant according to claim 1, wherein the head is a screw-shaped head.

5. The dental implant according to claim 1, which comprises a non-circular abutment between the threaded shaft and the coronal end.

6. The dental implant according to claim 1, which comprises a tapered collar between the threaded shaft and the coronal end.

7. The dental implant according to claim 1, which comprises a single antirotational cog.

8. The dental implant according to claim 1, which comprises a plurality of anti-rotational cogs.

9. The dental implant according to claim 8, which comprises three antirotational cogs positioned at 0°, 120° and 240° around the circumference of the threaded shaft.

10. The dental implant according to claim 7, wherein each cog defines a two-sided groove extending through the cutting threads into the shaft beneath, wherein said two sides are at an angle <90° relative to one another.

11. The dental implant according to claim 1, wherein the cutting threads have a variable profile both in terms of a thickness of the cutting edge of each thread, and of a taper from a bottom-most point of said cutting edge to the threaded shaft.

12. The dental implant according to claim 11, wherein the thickness of the cutting edge of each thread gradually decreases going from the coronal end to the apical end.

13. The dental implant according to claim 11, wherein the taper from the bottom-most point of said cutting edge to the threaded shaft gradually increases going from the coronal end to the apical end.

14. The dental implant according to claim 1, which comprises:
(a) a threaded shaft tapering to a point at said apical end;
(b) a head at said coronal end;
(c) a non-circular abutment between the head and the threaded shaft;
(d) a tapered collar between the non-circular abutment and the threaded shaft;
(e) a series of self-tapping cutting threads on said threaded shaft, wherein the cutting threads have a variable profile both in terms of a thickness of the cutting edge of each thread, and of a taper from a bottom-most point of said cutting edge to the threaded shaft, wherein the thickness of the cutting edge of each thread gradually decreases going from the coronal end to the apical end, and wherein the taper from the bottom-most point of said cutting edge to the threaded shaft gradually increases going from the coronal end to the apical end;
(f) one or a plurality of antirotational cogs traversing a plurality of said cutting threads, each cog defining a two-sided groove extending through the cutting threads into the shaft beneath, wherein said two sides are at an angle <90° relative to one another.

15. A non-surgical method of placing a dental implant, said method comprising:
(a) providing the dental implant according to claim 1;
(b) providing a starting bore through a patient's gum into said patient's jaw bone; and
(c) threading said dental implant through said starting bore into said patient's jaw bone.

16. The dental implant according to claim 6, wherein the tapered collar comprises a ring having a path following along a base; wherein the ring comprises a diversion, whereby the diversion inhibits cellular migration along the path of the ring.

17. The dental implant according to claim 16, wherein the diversion includes a junction with the base of the ring, wherein the junction is generally at a perpendicular relationship to the base.

18. The dental implant according to claim 16, wherein the diversion includes a junction with the base of the ring, wherein the junction has an angular relationship of between 45 degrees and 100 degrees from the base of the ring.

19. The dental implant according to claim 16, wherein the diversion has a plateau extending concentrically and at a distance from the base of the ring.

20. The dental implant according to claim 16, wherein the base of the ring has an arcuate profile.

21. An o-ring that fits upon the head of the dental implant according to claim 2.

22. A prosthetic application that is used upon or in conjunction with the dental implant according to claim 2.

23. The dental implant according to claim 8, wherein each cog defines a two-sided groove extending through the cutting threads into the shaft beneath, wherein said two sides are at an angle <90° relative to one another.
